(19) United States
(12) Patent Application Publication
(10) Pub. No.: US 2011/0120087 A1
(43) Pub. Date: May 26, 2011

(54) Apparatus with Catalyst for the Reduction of Nitrogen Dioxide (NO2) to Nitric Oxide (NO) by Chemical Means in a Diesel Catalytic Support

(75) Inventors: Thomas Richard ROBERTS, Rochester, NY (US); Dennis Roland Fronheiser, Rochester, NY (US); Thomas A. Iacubucci, Brockport, NY (US)

(73) Assignee: AirFlow Catalyst Systems, Rochester, NY (US)

(21) Appl. No.: 12/623,538

(22) Filed: Nov. 23, 2009

(51) Int. Cl. F01N 3/20; B01D 53/56; B01D 53/94

(52) U.S. Cl. 60/274; 423/213.2; 423/213.5; 60/297

(57) ABSTRACT

In setting tighter emissions standards for nitrogen oxides, legislative bodies limit the amount of nitrogen dioxide (NO₂) permitted in exhaust. The disclosed catalysts can be coated on a support device in a diesel engine exhaust system to increase the reduction of NO₂ to nitric oxide (NO). The disclosed coating comprises titanium dioxide, preferably in the form of rutile, comprising approximately 94% titanium dioxide and also comprising zirconium dioxide, silicon dioxide, iron(III) oxide, chromium oxide, vanadium oxide and aluminum oxide. In certain embodiments, a second coating comprised of palladium may be placed over the first coating of titanium dioxide or rutile.

This disclosure relates to the reduction of nitrogen dioxide to nitric oxide in diesel engine exhaust. More particularly, this disclosure relates to a catalyst on a support that provides increased reduction of nitrogen dioxide to nitric oxide in a diesel engine exhaust system.

### BACKGROUND OF THE INVENTION

Internal combustion engines, such as diesel engines, produce four major emissions: nitrogen oxides (NOx), particulate matter (material suspended in the air in the form of minute solid particles or liquid droplets), hydrocarbons and carbon monoxide. The regulatory focus for diesel engines is on NOx and hydrocarbons, although carbon monoxide and particulate matter are also of concern. The U.S. Environmental Protection Agency (EPA) established the first standards for new heavy-duty diesel engines for NOx and hydrocarbons for the 1974 model year. In 2002, the EPA finalized rules that required an approximate reduction by 50% in NOx emissions from newly manufactured heavy-duty diesel engines. In 1998, the EPA and other enforcement agencies brought an enforcement action against diesel engine manufactures relating to illegally-installed emissions control “defeat devices” in 1.3 million trucks over a 10 year period. As part of the consent decree, these manufacturers agreed to meet 2004 heavy-duty diesel engine emissions standards by Oct. 1, 2002. California and other states required that model year 2005 and 2006 heavy diesel engines meet the same procedures as prescribed in the consent decree. In 2001, EPA finalized regulations requiring substantially more stringent emissions limits for on-road heavy-duty diesel engines for NOx which phase in between 2007 through 2010. These standards cut 2004 model year emissions by an additional 90% and the 2007 standards were set approximately 50 times lower than those for 1974.

Nitrogen dioxide (NO₂) is toxic and can cause headaches, dizziness and nausea in low doses. It also has an objectionable smell. In setting tighter emissions standards for NOx, legislative bodies have also regulated the amount of nitrogen dioxide (NO₂) it is permissible to exhaust into the atmosphere. As of January 2009, all diesel emission control systems used to satisfy the California Air Resources Board in-use fleet rules must meet stricter rules for emissions limits for nitrogen dioxide (NO₂). The rules state NO₂ emissions may not be increased by more than 20% over the uncontrolled engine baseline. In 2007-2008,the emission limit was 30% over the uncontrolled engine baseline. EPA is continuing to analyze NO₂ data from verified technologies and is expected to propose increasingly strict regulations for NO₂ emissions. Reducing NO₂ emissions is now becoming necessary in most diesel engines.

The current means of meeting these increasingly stringent emissions standards is the use of complex methods, such as selective catalytic reduction (SCR) (which uses a gaseous reductant, typically anhydrous ammonia or aqueous ammonia); or another type of system which may use electrical current. The additional equipment used in these methods, including a tank to hold the reductant, is expensive, inefficient and difficult to maintain.

In conjunction with the removal of soot and other byproducts of diesel engines, catalytic converters have become ubiquitous in the industry. Although many types of catalytic converters exist, the focus has been on the removal of NOₓ from diesel exhaust as opposed to the removal of nitrogen dioxide (NO₂) This invention relates to a catalytic converter comprising a catalyst that converts NO₂ emissions.

### BRIEF DESCRIPTION OF THE DRAWINGS

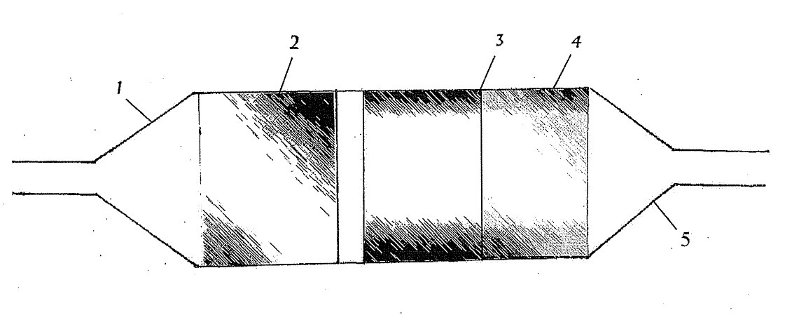

A schematic for the claimed apparatus is shown in FIG. 1, which shows the inlet from the engine 1, a flow through device 2, the diesel particulate filter 3, the claimed flow through device with the disclosed coating 4 and the exhaust outlet 5.

### BRIEF SUMMARY OF THE INVENTION

The disclosed invention relates to the reduction of nitrogen dioxide to nitric oxide in a diesel engine exhaust system. The disclosed catalysts can be coated on a support device, using methods well known in the art, to provide a component which can be incorporated in a diesel engine exhaust system to increase the reduction of nitrogen dioxide to nitric oxide. The support device may be a flow through device in a diesel engine. The disclosed coating, to be used on a support device, comprises titanium dioxide, preferably in the form of rutile. The catalyst may comprise approximately 94% titanium dioxide, and may also comprise zirconium dioxide, silicon dioxide, iron(III) oxide, chromium oxide, vanadium oxide and aluminum oxide. Preferably, the catalyst may comprise the foregoing compounds in the following percentages: zirconium dioxide (0-1%), silicon dioxide (0-1%), iron(III) oxide (0-0.1%), chromium oxide (0-0.06%), vanadium oxide (0-1%) and aluminum oxide (0-0.05%). In other embodiments, a second coating comprised palladium may be placed over the first coating of a titanium dioxide catalyst (preferably in the form of rutile) or a titanium dioxide catalyst containing up to approximately 4% by weight of the other oxides listed above.

### DETAILED DESCRIPTION OF THE INVENTION

The present invention relates to a catalyst for the reduction of nitrogen dioxide (NO₂) to nitric oxide (NO) by chemical means in a diesel catalytic support at up to 450° C. without the addition of other chemicals to the exhaust stream. The invention allows for the reduction of nitrogen dioxide (NO₂) emissions. The claimed catalyst uses a coating formed from rutile (TiO₂) including an optional coating consisting of palladium to reduce the amount of NO₂ in the gas exhausted from the diesel engine. This catalyst system also oxidizes, and therefore reduces the amount of, carbon monoxide (CO) and hydrocarbons formed during the combustion process, further assisting diesel engine systems in reducing compounds of regulatory interest.

The preferred embodiment of the invention is a flow-through type substrate coated with the disclosed catalyst that lowers the amount of nitrogen dioxide (NO₂) exhausted into the atmosphere without the need for any monitoring devices or external sources of chemicals or heat. The system removes the nitrogen dioxide from the diesel exhaust stream at a wide range of temperatures (under 450° C.).

Generally, the diesel engine system will contain a flow through device and a diesel particulate filter placed in a sealed container, such as one made of stainless steel, or other suitable material, to prevent the escape of gases. The diesel exhaust is directed into the flow through device and passes first through the flow through substrate component and then into the filter before being emitted into the atmosphere. A schematic for the claimed apparatus is shown in FIG. 1, which shows the inlet from the engine 1, a flow through device 2, the diesel particulate filter 3, the claimed flow through device with the disclosed coating 4 and the exhaust outlet 5.

The flow through substrate may be made from cordierite, stainless steel, or a primarily nonferrous metal. Alternatively, the flow through substrate may be made from a ceramic material or any other material common to use in the art. The substrate is coated with an oxide formulation which consists of titanium oxide preferably in the form of rutile. Ideally, the catalyst should be composed of approximately 94% titanium dioxide (TiO₂), preferably in the form of rutile, with the remainder of the composition comprising zirconium dioxide, silicon dioxide, iron(III) oxide, chromium oxide, vanadium oxide and/or aluminum oxide. Ideally, the percentages of the remaining elements should be as follows: zirconium dioxide (0-1%), silicon dioxide (0-1%), iron(III) oxide (0-1%), chromium oxide (0-0.06%), vanadium oxide (0-1%) and aluminum oxide (0-0.05%). The material is ground, calcined and remilled to an average particle size of 1 to 2 micro-meters. It is then dispersed in water to make a slurry which is coated on the substrate. The rutile coating will reduce the amount of nitrogen dioxide (NO₂) in the exhaust by approximately 50% in temperatures ranging from 100° C. to 500° C. The substrate is then preferably coated with palladium. With the second coating, the flow through device removes up to 80 to 85% of the nitrogen dioxide (NO₂) in temperatures ranging from 100° C. to 500° C. The structure of the coating is amorphous in nature with precipitated particle sizes in the range of 20-40 nanometers.

Another embodiment of the invention involves coating the substrate (flow through device) with the titanium oxide as described above. The substrate is then coated with palladium using an aqueous solution of water-soluble salts such as nitrate salts or nitrate salts of the tetraamine complexes. The corresponding metal is formed from the coated salts in a subsequent calcining step in the 400-500° C. range. The materials are then heat treated at 500° C. to stabilize the structure. As the coatings dry, they undergo a shrinkage process, causing micro-cracks to form in the surface and thereby increasing the surface area of the coating. The formation of micro-cracks also allows the penetration and the flow of gas through to the substrate. The heating process also bonds the individual grains to the surface of the substrate in much the same manner as an enamel adheres to the surface of a kitchen implement or a ceramic decoration adheres to a soda bottle.

The advantage of the invention, including the preferred embodiments described above, is, among other things, the ability to remove nitrogen dioxide (NO₂) from either treated or untreated diesel emissions under normal operating conditions for diesel engines. Another advantage of the invention, including the preferred embodiments, is that it uses a comparatively small amount of precious metals to conduct the reactions. The Group IV elements in the coating (including the titanium) also have the ability to oxidize carbon monoxide (CO) and hydrocarbons (HC) at lower temperatures as well, helping to meet other emissions goals for diesel engines. It is understood that the reduction catalyst claimed in this invention, coated on a flow-through type substrate, can be included in various positions in the diesel exhaust system, its exact placement being dependent on particular system requirements.

What is claimed is:

1. A method of reducing nitrogen dioxide in diesel engine exhaust comprising:
providing a substrate;
coating the substrate with a catalyst comprising titanium dioxide;
causing the diesel engine exhaust to flow over the titanium dioxide-coated substrate so that the nitrogen dioxide in said exhaust is reduced to nitric oxide; and
providing a particulate filter downstream of said substrate.

2. A method according to claim 1 wherein said titanium dioxide is in the form of rutile.

3. A method according to claim 1 wherein said catalyst comprises approximately 94% titanium dioxide.

4. A method according to claim 1 wherein said catalyst comprises approximately 94% titanium dioxide in the rutile form

5. A method according to claim 3 wherein said catalyst also comprises zirconium dioxide, silicon dioxide, iron(III) oxide, chromium oxide, vanadium oxide and aluminum oxide.

6. A method according to claim 4 wherein said catalyst also comprises zirconium dioxide, silicon dioxide, iron(III) oxide, chromium oxide, vanadium oxide and aluminum oxide.

7. A method according to claim 3 wherein said catalyst also comprises zirconium dioxide (0-1%), silicon dioxide (0-1%), iron(III) oxide (0-0.1%), chromium oxide (0-0.06%), vanadium oxide (0-1%) and aluminum oxide (0-0.05%).

8. A method according to claim 4 wherein said catalyst also comprises zirconium dioxide (0-1%), silicon dioxide (0-1%), iron(III) oxide (0-0.1%), chromium oxide (0-0.06%), vanadium oxide (0-1%) and aluminum oxide (0-0.05%).

9. A method according to claim 1 wherein a second coating comprised of palladium is placed over the titanium dioxide catalyst.

10. A method according to claim 2 wherein a second coating comprised of palladium is placed over the titanium dioxide catalyst.

11. A method according to claim 3 wherein a second coating comprised of palladium is placed over the titanium dioxide catalyst.

12. A method according to claim 4 wherein a second coating comprised of palladium is placed over the titanium dioxide catalyst.

13. A method according to claim 5 wherein a second coating comprised of palladium is placed over the titanium dioxide catalyst.

14. A method according to claim 6 wherein a second coating comprised of palladium is placed over the titanium dioxide catalyst.

15. A method according to claim 7 wherein a second coating comprised of palladium is placed over the titanium dioxide catalyst.

16. A method according to claim 8 wherein a second coating comprised of palladium is placed over the titanium dioxide catalyst.

17. A diesel engine exhaust system comprising: a housing having an inlet for receiving diesel exhaust; a ceramic or metal substrate within the housing, the substrate having a coating comprising titanium dioxide; a filter; and an outlet for emitting diesel exhaust.

18. A system according to claim 17 wherein said titanium dioxide is in the form of rutile.

19. A system according to claim 17 wherein said coating comprises approximately 94% titanium dioxide.

20. A system according to claim 17 wherein said coating comprises approximately 94% titanium dioxide in the form of rutile.

21. A system according to claim 19 wherein said coating also comprises zirconium dioxide, silicon dioxide, iron(III) oxide, chromium oxide, vanadium oxide and aluminum oxide.

22. A system according to claim 20 wherein said coating also comprises zirconium dioxide, silicon dioxide, iron(III) oxide, chromium oxide, vanadium oxide and aluminum oxide.

23. A system according to claim 19 wherein said coating also comprises zirconium dioxide (0-1%), silicon dioxide (0-1%), iron(III) oxide (0-0.1%), chromium oxide (0-0.06%), vanadium oxide (0-1%) and aluminum oxide (0-0.05%).

24. A system according to claim 20 wherein said coating also comprises zirconium dioxide (0-1%), silicon dioxide (0-1%), iron(III) oxide (0-0.1%), chromium oxide (0-0.06%), vanadium oxide (0-1%) and aluminum oxide (0-0.05%).

25. A system according to claim 17 wherein a second coating comprised of palladium is placed over the titanium dioxide coating.

26. A system according to claim 18 wherein a second coating comprised of palladium is placed over the titanium dioxide coating.

27. A system according to claim 19 wherein a second coating comprised of palladium is placed over the titanium dioxide coating.

28. A system according to claim 20 wherein a second coating comprised of palladium is placed over the titanium dioxide coating.

29. A system according to claim 21 wherein a second coating comprised of palladium is placed over the titanium dioxide coating.

30. A system according to claim 22 wherein a second coating comprised of palladium is placed over the titanium dioxide coating.

31. A system according to claim 23 wherein a second coating comprised of palladium is placed over the titanium dioxide coating.

32. A system according to claim 24 wherein a second coating comprised of palladium is placed over the titanium dioxide coating.
